(19) United States
(12) Patent Application Publication
(10) Pub. No.: US 2021/0219549 A1
(43) Pub. Date: Jul. 22, 2021

(54) MENADIONE COMPOSITIONS FOR TREATING PLANT DISEASES IN GRAPE PLANTS AND CITRUS

(71) Applicants: UNIVERSITY OF FLORIDA RESEARCH FOUNDATION, INC., Gainesville, FL (US); INTEGRATED PLANT GENETICS, INC., GAINESVILLE, FL (US)

(72) Inventors: Dean W. GABRIEL, Gainesville, FL (US); Mukesh JAIN, Gainesville, FL (US); Shujian ZHANG, Gainesville, FL (US); Tina STRAUSS, Gainesville, FL (US)

(21) Appl. No.: 17/256,337

(22) PCT Filed: Jun. 28, 2019
(86) PCT No.: PCT/US2019/039793

§ 371 Date: Dec. 28, 2020

Related U.S. Application Data
(60) Provisional application No. 62/691,022, filed on Jun. 28, 2018.

(51) Int. Cl. A01N 35/06

(52) U.S. Cl. CPC A01N 35/06

(57) ABSTRACT

Disclosed herein are methods of treating or improving resistance against Pierce's disease in Vitis vinifera via administration of a menadione containing composition. Also disclosed are methods of treating Citrus exhibiting symptoms of Huanglongbing disease.

### BACKGROUND

Pierce's disease (PD) is a lethal disease of grapevines in North America through Central America, and has been reported in parts of northwestern South America. The disease is caused by the insect vectored bacterial plant pathogen, Xylella fastidiosa (Xf). Xf is a fastidious, insect-vectored, Gram-negative, xylem-limited bacterium with a broad host range across 300 different plant species in 63 different families (Rapicavoli et al. 2018). Xf causes several economically important diseases other than PD of grapevines, including Citrus variegated chlorosis, alfalfa dwarf, phony peach disease, leaf scorch of plum and almond, periwinkle wilt, and the recently emerging olive quick decline syndrome. Xf strains are also associated with diseases in mulberry, pear, elm, sycamore, oak, maple, pecan and coffee (Purcell and Hopkins 1996; Rapicavoli et al. 2018). In grapevines, Xf cells multiply and spread readily from the site(s) of infection, leading to systemic colonization of the xylem in susceptible plants. Xylem occlusion results in marginally progressing leaf necrosis, desiccation of berries and abnormal abscission of petioles eventually resulting in death of the infected vines. Characteristic scorching of the leaves, although symptomatic of water stress, typically occurs in bands suggesting either toxin or pathogenicity effector activity (Goodwin et al. 1988; Stevenson et al. 2005; Thorne et al. 2006).

Economic consequences of PD to the California grape industry is estimated at $100 million per year (Alston et al. 2015). It is continually present in some California vineyards, and causes severe crop losses in the Napa Valley and parts of the Central Valley. It is also a constant presence in Florida, and is a primary reason why Vitis vinifera grapes cannot be profitably grown in Florida. PD is efficiently transmitted by the glassy-winged sharpshooter insect vector. In California, the glassy-winged sharpshooter has spread north into the Citrus belt of the Central Valley and probably will become a permanent part of various habitats throughout northern California. It feeds and reproduces on a wide variety of trees, woody ornamentals and annual plants in its region of origin, the southeastern United States. Crepe myrtle and sumac are especially preferred. It reproduces on Eucalyptus and coast live oaks in southern California.

Over the years, a great deal of effort has been focused on using insecticides to localize and eliminate the spread of this disease. However, there remains no effective treatment for PD. Other crops found in these regions of the State of California have also been effected, including the almond and oleander crops. The California Farm Bureau reports that there were 13 California counties infested with the glassy-winged sharpshooter in the year 2000, and that the threat to the State of California is $14 billion in crops, jobs, residential plants and trees, native plants, trees and habitats.

Huanglongbing, HLB, or Citrus greening disease was first reported in southern China in 1919 (Reinkinget, al., 1919), but it has been suggested to have originated in Africa. HLB is currently the most important bacterial disease of Citrus worldwide. HLB is found in Asia, the Middle East, Africa and the Americas. It is spread by the psyllid vectors Diaphorina citri and Trioza erytreae. The disease is now found in approximately 40 different Asian, African, North and South American countries and has become a serious threat across the U.S., Florida, California, Louisiana, Texas and Brazil, all of which are major Citrus producing locations. Citrus trees that become infected with the devastating disease go into decline, suffer premature fruit drop, off-flavor fruit, and then die after several years. The $1.4 billion annual Florida Citrus industry (Ewing, et al., 2006-2007) is so severely threatened by this disease that the industry may cease to exist in four to five years. Fruit production is now 70% below that of 6 years ago (from 147M boxes in 2011-12 to 45M boxes in 2017-18). Further, the disease now threatens to wipe out the $1.3 million annual Citrus industry in California. Presently, there is no cure for this disease, no resistant cultivars, and until this invention, no effective mitigating treatments. Citrus trees are routinely destroyed once severely infected with HLB.

HLB is caused by uncultured, phloem-restricted alpha-proteobacteria in the genus Candidatus Liberibacter. Three species are currently well described as causing HLB in Citrus—Ca. L. asiaticus (Las), Ca. L. africanus (Laf), and Ca. L. americanus (Lam)—and each species appears to have independently evolved in the continent reflecting its name (Beattie et al., 2005; Nelson et al., 2013). Other well described Ca. Liberibacter species with different insect vectors are known to cause serious diseases of solanaceous crops (Liefting et al. 2009; Munyaneza et al., 2009), less serious problems on celery (Teresani et al. 2014) and almost no symptoms at all on pear (Raddadi et al., 2011

Current methods in use for HLB control include the use of HLB-free Citrus seedlings, destruction of infected trees, and application of insecticides such as aldicarb (Temik®) or imidacloprid (Admire®). These insecticides are aimed at controlling psyllids, the insect vector for the disease, although in Florida, these insecticides have not had an effect on the spread of HLB, which is now in every commercial grove in the State. These insecticide treatments do not reduce disease in trees already infected, in any case. In Florida, foliar nutrition programs coupled with vector control are often used to slow down the spread of HLB and reduce devastating effects of the disease (Gottwald, 2010). These control practices have shown limited effect for preventing the further spread of HLB. Other than destruction and removal of diseased trees, there is no effective control for HLB in infected trees, and there is no known cure for HLB. New and improved treatments for Citrus (and other diseases caused by Liberibacters) are therefore are needed in the art.

Liberibacters and Xylella reside deep in the vascular tissues of plants, and are therefore unaffected by surface disinfectants or contact-dependent bactericides. Most bacterial pathogens enter plants through natural openings, such as stomata or hydathodes or through wounds in plant leaves, stems or roots. Most bacticides and disinfectants achieve their effects in a contact-dependent manner. Bacteria that are insect vectored are literally injected by the insects into the xylem (in the case of Xylella) or into the phloem (in the case of Liberibacters), and so are protected from contact by externally applied chemicals by the body of the vector and subsequent to infection, by the surrounding plant tissues. Once the bacteria have accessed the plant vascular system, they move long distances within the plant through active or passive processes. For any chemical treatment to be effective against these pathogens, the chemical must become systemic in the plant vascular tissues, whereupon it becomes highly diluted by the large volumes of plant sap that continuously move throughout the plant.

### BRIEF DESCRIPTION OF THE DRAWINGS

FIG. 1 Growth of Xylella fastidiosa cells at a cell volume of 150 μl/well in a 96 well format. PDT, wild type PD strain Temecula-1. TolC, a to/C mutant of PDT. Silwet L55 (Silwet) was added at 200 ppm to both PDT and TolC for evaluation purposes.

FIG. 2. Screening of the Prestwick Phytochemical Library of 320 compounds for growth inhibition of Xylella fastidiosa strain PDT. Growth of PDT in the presence of 320 chemicals (numbered along the horizontal axis) both with (orange dots) and without (blue dots) 200 ppm Silwet L-77. Both OD and GFP fluorescence were measured. Plates were incubated at 28° C. for two days, and both OD and GFP fluorescence again measured. Growth inhibition was calculated as the difference between the change in OD (not shown) or GFP fluorescence between treatments and the respective untreated control. Chemicals causing at least 50% growth inhibition relative to the respective untreated control were selected for additional screening at different concentrations to determine effective dose.

FIG. 3. Screening of the Prestwick Chemical Library of 1,280 compounds for growth inhibition of Xylella fastidiosa strain PDT. Legend as in FIG. 2.

FIG. 4. Phytotoxicity of menadione and benzethonium chloride to grape and tobacco leaves. Total chlorophyl content of leaf discs from grape plants treated for 18 hrs and from tobacco treated for 48 hrs with menadione (black bars) or benzethonium chloride (grey bars) at indicated concentrations Chlorophyll was extracted overnight in 80% acetone and quantified as described.

FIG. 5. Suppression of Pierce's Disease by menadione and benzethonium chloride treatments applied as soil drenches and sprays to artificially inoculated grapevines over a three month period. The chemical treatments were applied immediately after X. fastidiosa strain PDT inoculations of V. vinifera cv. Carignane vines, and repeated twice at monthly intervals. The bars represent the average (±SD) of 5 replicates for the treatment controls and 3 replicates for each of the chemical treatments A drench, menadione 5 mM; A foliar spray, menadione 15 mM; B drench, benzethonium chloride, 25 mM; B foliar spray, benzethonium chloride, 25 mM.

FIG. 6. Effect of menadione bisulfite (M) and benzethonium chloride (B) applied by soil drench or foliar spray on photosynthetic CO₂ assimilation rates (at 350 pbar leaf CO₂ concentration) on grapevine leaves (V. vinifera cv. Carignane) inoculated with X. fastidiosa strain PDT. The chemical treatments were applied immediately after X. fastidiosa inoculations. The gas exchange data were collected from four leaves from each plant one month post inoculation and treatments.

FIG. 7. Effect of menadione and benzethonium chloride treatments in a greenhouse trial applied as a soil drench or foliar spray on progression of PD symptoms on V. vinifera cv. Carignane grapevines over a three-month period. The chemical treatments were applied immediately after X. fastidiosa Temecula 1 inoculations and repeated twice at monthly intervals. The bars represent average ±SD for five replicates. Means (±SD) marked with different letters are significantly different based on Tukey-Kramer's mean separation (P<; 0.05).

FIG. 8. Effect of menadione bisulfite (M) applied by soil drench on metabolic activity of Ca. Liberibacter asiaticus (Las) in commercially grown infected grapefruit trees in the field. The chemical treatments were applied at least 8 years after infection by Las. Relative expression refers to the level of gene expression of Las peroxidase in comparison to the level of expression of Citrus gene Elongation Factor 1 alpha as a comparator. RNA was extracted from infected leaves of untreated control trees and compared with infected leaves of treated trees.

FIG. 9. Effect of menadione applied as a soil drench in field trials on levels of expression of a Las mRNA (groEL) in heavily infected commercial grapefruit trees (6 year old trees) after 25 to 27 days. The menadione treatment was to heavily infected, HLB symptomatic trees, the branches of which were tagged and confirmed positive for Las infection by PCR prior to treatment. The bars represent average ±SE for the indicated number of independent samples (37 to 47 for each treatment). Means (±SE) marked with asterisks were significantly different based on both Student's T test, and by Tukey-Kramer's mean separation (P<; 0.05).

### DETAILED DESCRIPTION

Techniques are provided for improving the health and disease resistance of plants, including important crop plants such as Citrus or grape plants (Vitis vinifera). The methods also provide treatment and control of plant diseases in plants affected or susceptible to the disease using a menadione-containing composition (MCC). The MCC can be applied to plants to treat a plant disease, such as Pierce's Disease in grape plants or HLB in Citrus, improve resistance to disease, improve the ability to defend against disease, reduce disease symptoms, minimize decreases in crop yield due to a plant disease, improve crop productivity and crop quality in Citrus, and increase juice content and juice quality in Citrus. Therefore, the MCC can be used to benefit healthy grape plants and diseased grape or Citrus plants. The methods described herein involve application of the MCC to the plant, including application to the soil around the plant by injection or soil drench methods, application to the surface of the plant, such as by spraying onto the plant or parts of the plant, such as by foliar spraying, or injection into the plant such as by trunk injection.

A specific embodiment relates to treating HLB in affected Citrus trees. Another embodiment relates to treating Pierce's disease in Vitis vinifera.

Menadione or derivatives thereof may be formulated in any suitable vehicle for application to the plant to be treated. For example, it may be convenient to dissolve the chemical in water or in an alcoholic solution, which is then diluted with water for application to the plant. Spraying the affected plant or trunk injection into the plant are specifically contemplated; however, any application method known in the art can be used, e.g., chemigation, soil injection, and soil drench.

Still other aspects, features, and advantages are readily apparent from the following detailed description, simply by illustrating a number of particular embodiments and implementations, including the best mode contemplated for carrying out the invention. Other embodiments also are capable of other and different features and advantages, and its several details can be modified in various obvious respects, all without departing from the spirit and scope of the invention. Accordingly, the drawings and description are to be regarded as illustrative in nature, and not as restrictive.

The purpose of the studies described herein was to evaluate the effects of menadione treatment on disease progression (for example HLB progression) and crop production under field conditions in order to determine the feasibility of using these treatments, and of using plant defense inducers generally, as a method for the control and management of crop plant populations. Treatment of a plant with a MCC will slow down HLB disease progress and sustaining fruit productivity.

Therefore, embodiments of the invention include a method of treating a plant disease in a Citrus plant or grape plant in need thereof comprising administering to the Citrus plant a composition which comprises a botanically compatible vehicle and menadione or salt thereof, a menadione derivative or a salt thereof; or any combination thereof. Certain embodiments involve administration of menadione or menadione derivative in concentrations ranging from 15 μM to 1000 mM, preferably at concentrations of 15 μM, 50 μM, 100 μM, 150 μM, 200 μM, 500 μM, 750 μM or 1 mM, and more preferably at concentrations of 15 μM, 150 μM, 200 μM or 1 mM for grapes and at concentrations of 10 mM, 100 mM or 1 M for mature Citrus trees in field situations. Certain embodiments involve utilizing quantities of benzithonium chloride and/or menadione ranging from 1 gram to 20 grams per tree in soil drenches involving field grown Citrus.

In one embodiment, a method of treating Pierce's Disease in a Vitus vinifera plant infected with Xf, comprises administering (e.g. foliar spraying or soil drenching) to the Vitus vinifera plant with an MCC. A related embodiment is a method of preventing the development of Pierce's Disease in a Vitus vinifera plant, and comprises administering to the Vitus vinifera plant an MCC.

In another embodiment, a method of treating HLB in Citrus plants of any species infected with Las, whether grapefruit (Citrus paradisi), sweet orange (Citrus sinensis), pomelo (Citrus maxima), citron (Citrus medica), tangerine (Citrus reticulata), lime (Citrus glauca, Citrus australis or Citrus australasica), comprises administering (e.g. foliar spraying or soil drenching) solutions of up to 1 M to the Citrus tree with an MCC. A related embodiment is a method of preventing the development of HLB in a Citrus tree, and comprises administering to the Citrus tree an MCC.

Methods according to embodiments of the invention involve treating when the plant disease is a bacterial disease or a fungal disease, preferably wherein the plant disease is HLB disease or wherein the plant is infected with HLB disease or has symptoms of HLB disease. In particular, embodiments involve treating when the plant is infected with a Candidatus Liberibacter species, such as, for example, wherein the Candidatus Liberibacter species is selected from the group consisting of Candidatus Liberibacter asiaticus, Candidatus Liberibacter americanus, Candidatus Liberibacter africanus, and any combination thereof.

Plants contemplated for the embodiments of the invention include members of the family Rutaceae, preferably members of the genus Citrus. Citrus plants can be selected from the group consisting of Citrus maxima (Pomelo); Citrus medica (Citron); Citrus micrantha (Papeda); Citrus reticulata (Mandarin orange); Citrus trifolata (trifoliate orange); Citrus japonica (kumquat); Citrus australasica (Australian Finger Lime); Citrus australis (Australian Round lime); Citrus glauca (Australian Desert Lime); Citrus garrawayae (Mount White Lime); Citrus gracilis (Kakadu Lime or Humpty Doo Lime); Citrus inodora (Russel River Lime); Citrus warburgiana (New Guinea Wild Lime); Citrus wintersii (Brown River Finger Lime); Citrus halimii (limau kadangsa, limau kedut kera) Citrus indica (Indian wild orange); Citrus macroptera; Citrus latipes; Citrus x aurantiifolia (Key lime); Citrus x aurantium (Bitter orange); Citrus x latifolia (Persian lime); Citrus x limon (Lemon); Citrus x limonia (Rangpur); Citrus x paradisi (Grapefruit), Citrus x sinensis (Sweet orange); Citrus x tangerina (Tangerine); Poncirus trifoliata x C. sinensis (Carrizo citrange), C. paradisi “Duncan” grapefruit x Pondirus trifoliate (Swingle citrumelo), Imperial lemon; tangelo; orangelo; tangor; kinnow; kiyomi; Minneola tangelo; oroblanco; sweet orange; ugli; Buddha's hand; citron; lemon; orange; bergamot orange; bitter orange; blood orange; calamondin; clementine; grapefruit; Meyer lemon; Rangpur; tangerine; and yuzu.

An additional disclosed embodiment pertains to a method of minimizing decrease in crop yield due to a plant disease in a Citrus plant or grape plant population, which method comprises administering to the plants of the population an MCC. These methods can involve administering to the plant by soil drench or soil injection, or by foliar spraying, with or without mechanical or chemical penetrants to assist chemical delivery.

The invention is described herein with reference to specific embodiments. However, various modifications and changes can be made to the invention without departing from its broader spirit and scope. The specification and drawings therefore are to be regarded as illustrative rather than restrictive. Throughout this specification and the claims, unless the context requires otherwise, the word “comprise” and its variations, such as “comprises” and “comprising,” are used to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

While a number of embodiments of the present invention have been shown and described herein in the present context, such embodiments are provided by way of example only, and not of limitation. Numerous variations, changes and substitutions will occur to those of skill in the art without materially departing from the invention herein. Any means-plus-function and step-plus-function clauses are intended to cover the structures and acts, respectively, described herein as performing the recited function and not only structural equivalents or act equivalents, but also equivalent structures or equivalent acts, respectively. Accordingly, all such modifications are intended to be included within the scope of this invention as defined in the following claims, in accordance with relevant law as to their interpretation.

### Definitions

All technical and scientific terms used herein, unless defined herein, are intended to have the same meaning as commonly understood by one of ordinary skill in the art. The techniques employed herein are also those that are known to one of ordinary skill in the art, unless stated otherwise.

The term “applying,” “application,” “administering,” “administration,” and all their cognates, as used herein, refers to any method for contacting the plant with menadione. Administration generally is achieved by application of a menadione containing composition (MCC) that typically includes menadione in a vehicle compatible with the plant to be treated (i.e., a botanically compatible vehicle or carrier), such as an aqueous vehicle, to the plant or to the soil surrounding the plant or by injection into the plant. Any application means can be used, however preferred application methods include trunk injection and foliar spraying as described herein. Other methods include application to the soil surrounding the plant, by injection, soaking or spraying, so that the applied compounds can come into contact with the plant roots and can be taken up by the roots.

The term “botanically acceptable carrier/vehicle” or “botanically compatible carrier/vehicle,” as used herein, refers to any non-naturally occurring vehicle, in liquid, solid or gaseous form which is compatible with use on a living plant and is convenient to contain a substance or substances for application of the substance or substances to the plant, its leaves or root system, its seeds, the soil surrounding the plant, or for injection into the trunk, or any known method of application of a compound to a living plant, preferably a crop plant, for example a Citrus tree.

Useful vehicles can include any known in the art, for example liquid vehicles, including aqueous vehicles, such as water, solid vehicles such as powders, granules or dusts, or gaseous vehicles such as air or vapor. Any vehicle which can be used with known devices for soaking, drenching, injecting into the soil or the plant, spraying, dusting, or any known method for applying a compound to a plant, is contemplated for use with embodiments of the invention. Typical carriers and vehicles contain inert ingredients such as fillers, bulking agents, buffers, solvents, preservatives, anti-caking agents, pH modifiers, surfactants, soil wetting agents, adjuvants, and the like. Suitable carriers and vehicles within this definition also can contain additional active ingredients such as plant defense inducer compounds, nutritional elements, fertilizers, pesticides, and the like.

The term “Citrus” or “Citrus”, as used herein, refers to any plant of the genus Citrus, family Rutaceae, and includes Citrus maxima (Pomelo), Citrus medica (Citron), Citrus micrantha (Papeda), Citrus reticulata (Mandarin orange), Citrus trifolata (trifoliate orange), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera); Citrus indica (Indian wild orange), Citrus macroptera, and Citrus latipes. Hybrids also are included in this definition, for example Citrus x aurantiifolia (Key lime), Citrus x aurantium (Bitter orange), Citrus x latifolia (Persian lime), Citrus x limon (Lemon), Citrus x limonia (Rangpur), Citrus x paradisi (Grapefruit), Citrus x sinensis (Sweet orange), Citrus x tangerina (Tangerine), Poncirus trifoliata x C. sinensis (Carrizo citrange), and any other known species or hybrid of genus Citrus. Citrus known by their common names include, Imperial lemon, tangelo, orangelo, tangor, kinnow, kiyomi, Minneola tangelo, oroblanco, sweet orange, ugli, Buddha's hand, citron, lemon, orange, bergamot orange, bitter orange, blood orange, calamondin, clementine, grapefruit, Meyer lemon, Rangpur, tangerine, and yuzu, and these also are included in the definition of Citrus or Citrus.

The term “effective amount” or “therapeutically effective amount,” as used herein, means any amount of the compound or composition which serves its purpose, for example, treating plant disease, improving the ability of plants to defend against disease, reducing disease symptoms, treating HLB disease in Citrus, treating Pierce's Disease in Vitis vinerfera, minimizing crop yield decreases due to plant disease, improving crop productivity, and increasing crop quality.

The term “health,” as used herein, refers to the absence of illness and a state of well-being and fitness, and refers to the level of functional or metabolic efficiency of the plant, including the ability to adapt to conditions and to combat disease, while maintaining growth and development. The term “vigor,” as used herein, refers to the health, vitality and hardiness of a plant, and its capacity for natural growth and survival. Therefore, the phrase “health and vigor of a plant,” as used herein, means the absence of illness, a high level of functional or metabolic efficiency, the ability to combat disease, and the maintenance of good growth and development, and the efficient production of crops.

The term “healthy,” as used herein, refers to a plant or plant population which is not known currently to be affected by a plant disease. For example, a healthy plant lacks symptoms of disease.

The term “Huanglongbing,” “Huanglongbing disease,” or “HLB,” as used herein, refers to a disease of plants caused by microorganisms of the Candidatus genus Liberibacter, such as L. asiaticus, L. africanus, and L. americanus. This disease, for example, can be found in Citrus plants, or other plants in the genus Rutaceae. Symptoms of Huanglongbing disease include one or more of yellow shoots and mottling of the plant leaves, occasionally with thickening of the leaves, reduced fruit size, fruit greening, premature dropping of fruit from the plant, low fruit soluble acid content, fruit with a bitter or salty taste, or death of the plant.

The term “improved ability to defend against disease,” as used herein, refers to a measurable increase in plant defense against a disease. This can be measured in terms of a measurable decrease in disease symptoms, pathogen titer, or loss of crop yield and/or quality, or a measurable increase in growth, crop quantity or quality.

The term “improved crop productivity,” as used herein, refers to a measurable increase in the quantity of a crop in a plant or a population of plants, in terms of numbers, size, or weight of crop seeds, fruits, vegetable matter, fiber, grain, and the like.

The term “improved crop quality,” as used herein, refers to a measurable increase in the quality of a crop, in terms of numbers, size, or weight of crop seeds, fruits, vegetable matter, fiber, grain, and the like, or in terms of sugar content, juice content, unblemished appearance, color, or taste.

The term “improved resistance to disease,” as used herein, refers to an increase of plant defense in a healthy plant or a decrease in disease severity of a plant or a population of plants, or in the number of diseased plants in a plant population.

The term “measurable increase” (or “measurable decrease”), as used herein, means an increase (or decrease) that can be detected by assays known in the art as greater (or less) than control. For example, a measurable increase (or decrease) is an increase (or decrease) of about 2%, about 5%, about 10%, about 20%, about 30%, about 40%, about 50%, about 60%, about 70%, about 75%, about 80%, about 85%, about 90%, or more, compared to plants or a plant population not treated with the active ingredient.

The term “menadione” or “Vitamin K3” refers to 2-methyl-1,4-naphthalene-dione or 2-methyl-1,4-naphthoquinone, Merck index=5714, C.A.R.N.=[58-27-5]. Unless specifically specified otherwise, the term “menadione” as used herein also includes water soluble derivatives menadione (such as the different addition compounds formed with sodium bisulphite (menadione sodium bisulphite or MSB, M.I.=5716, C.A.R.N.=[130-37-0], or with potassium bisulphite, or with ammonium bisulphite, or with magnesium bisulphite), and other Vitamin K3 derivatives of low solubility in water (such as menadione nicotinamide bisulphite or MNB, menadione p-amino benzoic acid bisulphite, menadione histidine bisulphite, menadione adenine bisulphite, menadione nicotinic acid bisulphite and menadione tryptophan bisulphite). Also included are acceptable salt versions of menadione.

The term “minimizing crop yield decreases due to plant disease,” as used herein, refers to reducing the decrease in crop yield which is seen when a plant is infected with a disease or plant pathogen.

The term “plant in need thereof,” as used herein, means any plant which is healthy or which has been diagnosed with a plant disease or symptoms thereof, or which is susceptible to a plant disease, or may be exposed to a plant disease or carrier thereof.

The term “plant disease,” as used herein, refers to any disease of a crop plant, caused by any plant pathogen, including but not limited to bacterial, viral, fungal, nematode, phytomyxean, protozoan, algal and parasite plant pathogens.

The term “plant disease symptoms,” as used herein, refers to any symptom of disease, including the detectable presence of a known plant pathogen. Symptoms of Pierce's disease include inhibited periderm development in stems (green islands), leaf blade separation from the petiole (matchsticks), or irregular leaf scorch. Symptoms of HLB include rot, mottling, galls, discoloration such as yellowing or browning, fruit greening, stunted growth, plant death, cellular death, cell wall breakdown, the presence of spots, the presence of lesions, dieback, wilting, dwarfing, knots, and Witch's broom.

The term “population of plants,” as used herein, refers to a group of plants, all of the same species, that inhabit a particular area at the same time. Therefore, the plants in a nursery, vineyard, a grove, a farm, and the like are considered a population. Inhabiting a particular area with respect to two or more plants means that the two or more plants are within 1000 meters each other.

The term “reduction of disease symptoms,” as used herein, refers to a measurable decrease in the number or severity of disease symptoms.

The term “treating” or “treatment,” or its cognates, as used herein indicates any process or method which cures, diminishes, ameliorates, or slows the progress of the disease or disease symptoms. Thus, treatment includes reducing bacterial titer in plant tissues or appearance of disease symptoms relative to controls which have not undergone treatment. Treating or treatment includes any application or administration to a plant, the soil surrounding the plant, the water applied to the plant, or the hydroponic system in which the plant is grown, which is intended to improve the health, growth or productivity of a plant, particularly a crop plant.

### Overview

The embodiments disclosed herein are based on two discoveries made during the course of basic research on Xylella fastidiosa. The first discovery is our demonstration that the Type I multidrug resistance (MDR) efflux system of X. fastidiosa (Xf) is absolutely required for both pathogenicity and even brief survival of the Pierce's Disease (PD) pathogen in grape (Reddy et al., 2007). Knockout mutations of either to/C or acrF (manuscript in preparation) render Xf nonpathogenic, and in addition, the to/C mutants were so highly sensitive to grape chemicals that the mutants are not recovered after inoculation. Inoculation of very high titers of Xf strain Temecula to/C mutants in grape results in rapid, 100% killing of inoculated bacteria. These results demonstrated a critical role for Type I efflux in general and TolC and AcrF in particular for defensive efflux by Xf of plant antimicrobial compounds, such as phytoalexins.

In the process of investigating the increased sensitivity of the MDR efflux mutants to plant-derived antimicrobial chemicals, we also discovered that even wild type Xf, with its lone MDR efflux system, is much more sensitive to plant-derived antimicrobial chemicals than most other plant pathogens, which carry multiple efflux systems. Both tolc (encoding the outer membrane and periplasmic tunnel component of Type I secretion) and acrF (encoding the inner membrane pump component of Type I secretion) are essential for MDR efflux in Xf, which has only one copy of each gene and only one such MDR efflux system. Similarly, the pathogenic Liberibacter species either have a single tolC, or, in the case of Lam, no tolC at all. By contrast, most plant pathogens have redundant MDR efflux systems and multiple to/C genes. These results suggest that Xf on any plant host should be much more vulnerable to chemical treatments affecting Type I efflux than other bacterial plant pathogens.

MDR efflux mutants in other systems have provided proven, highly sensitive and quantitative screening methods for antimicrobial chemicals (Tegos et al., 2002). The goal of this project is to exploit the increased vulnerability of Xf and our knowledge of particular chemicals that require efflux in a high throughput assay that screens small molecule combinatorial libraries and Xf-resistant grapevines for chemicals that may disable Type I secretion directly or indirectly. A highly sensitive live cell assay that is well suited for high throughput screening was developed and used for this screening.

### Methods of Administration

Methods of administration to plants include, by way of non-limiting example, application to any part of the plant, by inclusion in irrigation water, by injection into the plant or into the soil surrounding the plant, by exposure of the root system to aqueous solutions containing the compounds, by use in hydroponic or aeroponic systems, by culture of individual or groups of plant cells in media containing menadione, by seed treatment, by exposure of cuttings of Citrus plants used for grafting to aqueous solutions containing the compounds, by application to the roots, stems or leaves, or by application to the plant interior, or any part of the plant to be treated. Any means known to those of skill in the art is contemplated. Preferred modes of administration include those where the compounds are applied at, on or near the roots of the plant, or trunk injection.

Application of menadione can be performed in a nursery setting, a greenhouse, hydroponics facility, or in the field (e.g. population of plants such as a grove or vineyard) or any setting where it is desirable to treat plants to prevent the likelihood of disease, or to treat disease and its effects, for example in plants which have been or can become exposed to (i) Pierce's disease or Xf infection, or (ii) HLB or Ca. Liberibacter infection. Thus, any plant in need, in the context of this invention, includes any and all plants for which improvements in health and vigor, growth and productivity or ability to combat disease is desired.

Application to seeds preferably is accomplished as follows, however any method known in the art can be used. Seeds may be treated or dressed prior to planting, by soaking the seeds in a solution containing the compounds at a dosage of active ingredient over a period of minutes or hours, or by coating the seeds with a carrier containing the compounds at a dosage of active ingredient. The concentrations, volumes, and duration may change depending on the plant.

Application to soil preferably is performed by soil injection or soil drenching, however any method known in the art can be used. These methods of administration are accomplished as follows. Soil drenching may be performed by pouring a solution or vehicle containing the compounds at a dosage of active ingredient at 0.5 to 1 gallons/tree to the soil surface in a crescent within 10 to 100 cm of the trunk on the top side of the bed to minimize runoff, and/or by using the irrigation system. Soil injection may be performed by directly injecting a solution or vehicle containing the compounds at a dosage of active ingredient into the soil within 10 to 100 cm of the trunk using a soil injector. The concentrations, volumes, and duration may change depending on the plant. These soil application methods are preferred with the compounds BABA and 2-DDG.

Application to hydroponic or culture media preferably is performed as follows, however any method known in the art can be used. A solution or vehicle containing the compounds at a dosage of active ingredient may be added into the hydroponic or culture media at final concentrations suitable for plant growth and development. The concentrations, and volumes may change depending on the plant.

Application to the roots preferably is performed by immersing the root structure in a solution or vehicle in a laboratory, nursery or hydroponics environment, or by soil injection or soil drenching to the soil surrounding the roots, as described above. Emersion of the root structure preferably is performed as follows, however any method known in the art can be used. A solution or vehicle containing the compounds at a dosage of active ingredient may be applied to the roots by using a root feeder at 0.5 to 1 gallons per tree. The concentrations, volumes, and duration may change depending on the plant.

Application to the stems or leaves of the plant preferably is performed by spraying or other direct application to the desired area of the plant, however any method known in the art can be used. A solution or vehicle containing menadione at a dosage of active ingredient may be applied with a sprayer to the stems or leaves until runoff to ensure complete coverage, and repeat three or four times in a growing season. The concentrations, volumes and repeat treatments may change depending on the plant.

Application to the plant interior preferably is performed by injection directly into the plant, for example by trunk injection or injection into an affected limb, however any method known in the art can be used.

### Compositions

Preferably, menadione is administered in the form of a composition containing a botanically compatible vehicle. Suitable amounts for administration to a plant are in the range of about 20 mL to about 1000 mL for trunk injection, the range of about 0.1 gallons per tree to about 0.8 gallons per tree for foliar spraying, and the range of about 0.25 gallons per to about 2 gallons per tree for soil drench and soil injection methods. Therefore, for trunk injection, amounts to be administered to a plant are about 20 mL to about 1000 mL, preferably about 100 mL to about 800 mL, and most preferably about 300 mL to about 600 mL. For foliar spraying, amounts to be administered to a plant are about 0.1 gallons per tree to about 0.8 gallons per tree, preferably about 0.2 gallons per tree to about 0.6 gallons per tree, and most preferably about 0.25 gallons per tree to about 0.5 gallons per tree. For soil drench and soil injection, amounts to be administered to a plant are about 0.125 gallons (pint) 0.25 gallons (quart) per tree to about 2 gallons per tree, preferably about 0.3 gallons per tree to about 1.5 gallons per tree, and most preferably about 0.125 gallons per tree to about 0.25 gallon per tree. Persons of skill in the art are able to adjust these amounts taking into account the plant size, timing of application and environmental conditions.

Concentrations of the compounds in the compositions can be in the range of about 0.05 mM to about 1 M, preferably about 10 mM to about 100 mM, and most preferably about 50 mM. Persons of skill in the art are able to adjust these concentrations taking into account the plant size, timing of application and environmental conditions.

Compositions according to embodiments of the invention preferably include a botanically acceptable vehicle or carrier, preferably a liquid, aqueous vehicle or carrier such as water, and at least one compound according to the invention. The composition may be formulated as an emulsifiable concentrate(s), suspension concentrate(s), directly sprayable or dilutable solution(s), coatable paste(s), dilute emulsion(s), wettable powder(s), soluble powder(s), dispersible powder(s), dust(s), granule(s) or capsule(s).

The composition may optionally include a botanically acceptable carrier that contains or is blended with additional active ingredients and/or additional inert ingredients. Active ingredients which can be included in the carrier formulation can be selected from any combination of pesticides, herbicides, plant nutritional compositions such as fertilizers, and the like. Additional active ingredients can be administered simultaneously with the plant defense inducer compounds described here, in the same composition, or in separate compositions, or can be administered sequentially.

Inert ingredients which can be included in the carrier formulation can be selected from any compounds to aid in the physical or chemical properties of the composition. Such inert ingredients can be selected from buffers, salts, ions bulking agents, colorants, pigments, dyes, fillers, wetting agents, dispersants, emulsifiers, penetrants, preservatives, antifreezes, evaporation inhibitors, bacterial nutrient compounds, anti-caking agents, defoamers, antioxidants, and the like.

Some specific embodiments of the invention are described below in the context of the Examples herein, which exemplify methods of applying plant defense inducer compounds by spraying or by injection into the trunk. Persons of skill are aware of various methods to apply chemicals to plants for surface application or for uptake, and any of these methods are contemplated for use in this invention. By way of non-limiting example, the plant defense inducer compounds of this invention may be applied to any susceptible plant by spraying or by any other convenient physical application to any surface of the plant, by inclusion in irrigation water, by injection, by exposure of the root system to aqueous solutions containing the compounds, by use in hydroponic or aeroponic systems, by culture of individual or groups of plant cells in media containing the inducer, seed treatment by exposure of seeds for seedling emergence and establishment, or by exposure of cuttings of Citrus plants used for grafting to aqueous solutions containing the compounds, or by any means known to those of skill in the art.

### 4. EXAMPLES

### Example 1: Screen Two Prestwick Combinatorial Libraries for Chemicals Affecting Xylella fastidiosa (Xf)

Initial experiments focused on Xf culturing conditions (starting optical density and cell volumes) that would be adequate to obtain reproducible results in a chemical screen for Xf growth using a 96 well microtiter plate format. Two day old cultures of GFP-marked Temeculal cells (OD600=0.25) were diluted to starting OD=0.05 and used for seeding 96-well microtiter plates for high throughput screening of the chemical libraries.

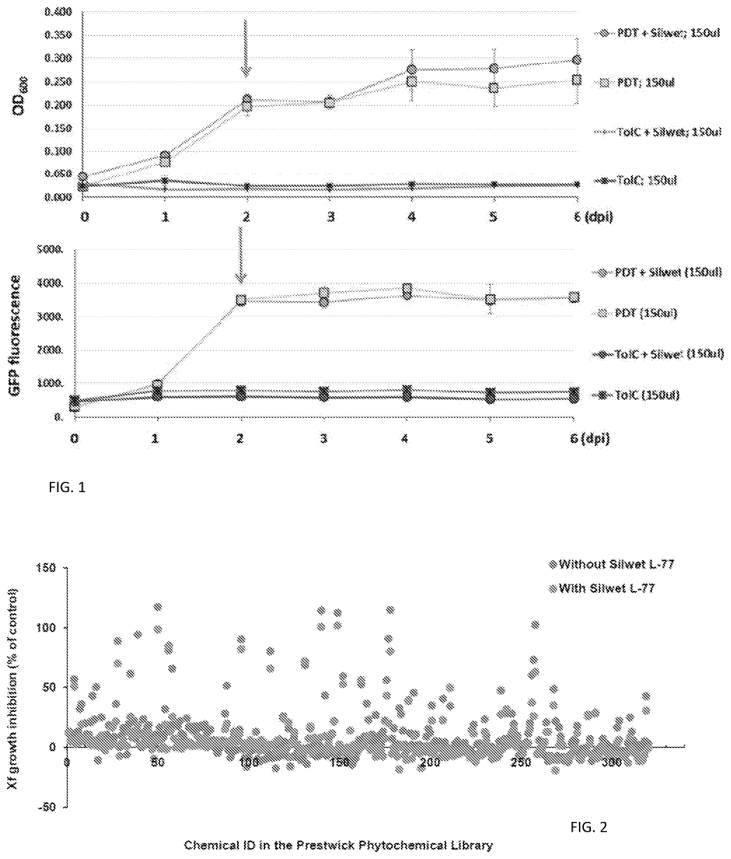

Cell volumes of 100, 150, and 200 μl/well were tested at 28° C. Overall, 150 μl/well volumes were determined to be practical and reproducible for observing growth (refer FIG. 1). Bacterial growth was measured at 48 hours after inoculation, both as (correlated) increase in optical density (OD600) and GFP fluorescence (excitation at 485/20 nm and emission at 528/20 nm) (Steff et al., 2001).

As can be observed from FIG. 1, maximum growth fluorescence emission was observed at 48 hrs after seeding the plates using 150 μl volumes, and therefore chemical treatments were added at the time of plate seeding, and effects of the treatments were evaluated 48 hrs later. Silwet L77 at 200 ppm had no effect on growth of the wild type strain Temecula-1

For the primary chemical screens, plates were preloaded with Temecula-1 cells with or without 200 ppm Silwet L-77 and with each tested chemical loaded at a concentration of 50 μM. Each chemical in the Prestwick Phytochemical and Chemical libraries was screened in two separate experiments per library. The statistical parameter (Z′) was used to evaluate the quality of the assays exactly as described (Zhang et a. 1999). The overall Z′ value for the Prestwick Phytochemical library was 0.76 and the overall Z′ for the Prestwick Chemical library was 0.78; these values are within the statistically “excellent” reproducibility range (Z′>0.75; Zhang et al., 1999).

The Z′ factor (Zhang et al., 1999) was calculated according to the following formula: Z′=1−[(3σ−CK+3σ+CK)/(μ−CK−μ+CK)], where σ are standard deviations and a are the average fluorescence read changes of the positive and negative controls over a period of 48 hrs. The average fluorescence read changes of negative control (μ−CK) and the fluorescence read change of each chemical (f) were used to calculate the percent inhibitory activity according to the following equation: % inhibition=[1−f/μ−CK]×100. Three experiments were done on different days.

Significant growth inhibition (>50%) of Temeculal was observed with 22 phtochemicals (FIG. 2), eight of which exhibited strongly significant growth inhibition (>90%). These were menadione, 9-methoxyellipticine, olivacine, gossypol, 4,4′-(2,3 dimethyltetramethylene) dipyrocatechol and roseoflavin. Of these, all but gossypol exhibited 100% inhibition at 25 uM. Greater than 100% inhibition occurred when the optical density (data not shown) and the fluorescence emitted was reduced to below that of the starting cell values, and indicated lysis. None of the 320 phytochemical library compounds was found to enhance growth. None of the 320 phytochemical library compounds exhibited enhanced inhibition in the presence 200 ppm Silwet L-77, indicating that these were not significantly affected by multidrug efflux at the concentrations used. Eleven phytochemicals, including some natural antibiotics, were identified as strongly inhibitory (>80%) at 50 μM, including the phytoalexin gossypol and the alkaloids remerine and olivicine.

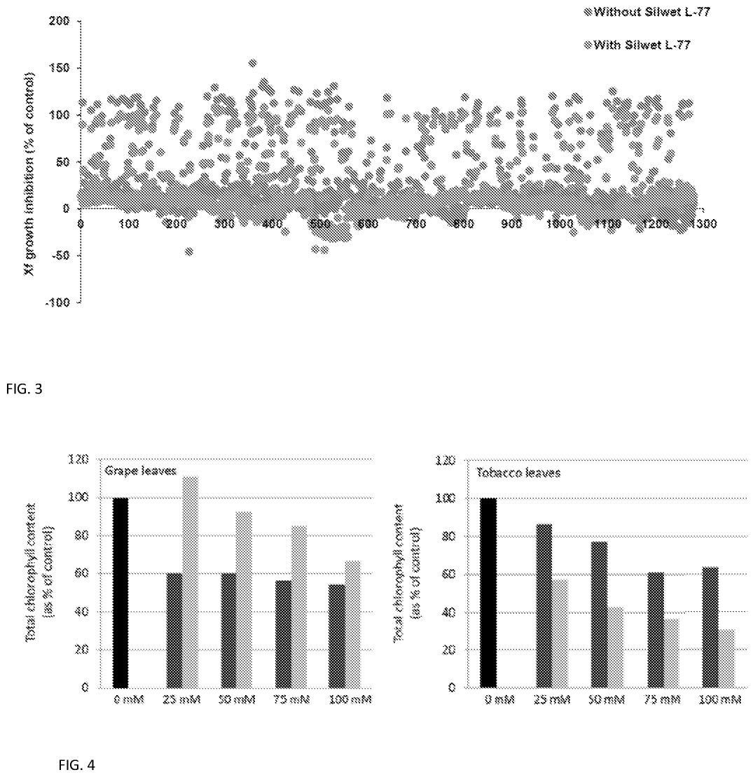

Significant growth inhibition (>50%) of Temeculal was observed with 193 chemicals from the Prestwick Chemical library (FIG. 3). Among them, 30 chemicals exhibited growth inhibition between 90-100% as compared to controls and 91 chemicals exhibited 100% grow inhibition at 50 μM. Some chemicals were either antibiotics and/or have major pharmaceutical uses, for example tetracycline, chlortetracycline, erythromycin, puromycin, rifampicin and minocycline. These were eliminated from further consideration because of anticipated regulatory concerns. Five chemicals exhibited 100% inhibition at 25 μM: Pinaverium bromide, Methyl benzethonium chloride, Benzethonium chloride and Nitazoxanide.

Over 120 chemicals were identified that inhibited growth of Xf by >90% @ 50 μM, including 46 chemicals that appeared to lyse Xf cells. Seven chemicals proved to lyse Xf cells at 25 μM, including four phytochemicals. Four of these chemicals were eliminated from further consideration because they have pharmaceutical uses and would likely face severe regulatory hurdles, and one due to cost considerations. Two chemicals, menadione and benzethonium chloride, were further evaluated as potential treatments for PD by both soil drench and spray applications.

Phytotoxicity to grape and tobacco leaves was also evaluated using chlorophyll loss as a sensitive indicator of phytotoxicity (Jain et al. 2012). Three leaf disc explants (10 mm diameter punches) from young fully expanded grapevine leaves (V. vinifera cv. Carignane) and tobacco leaves were floated on MS basal medium (Murashige and Skoog 1962) amended with different concentrations of menadione sodium bisulfite (hereafter referred to as menadione) and benzethonium chloride, Three days after treatment, leaf pigments were extracted in 80% acetone and total chlorophyll content was quantified as described by Arnon et al. (1949). Photosynthetic CO₂ assimilation rates were measured in control, X. fastidiosa-inoculated and chemical-treated grapevines with a portable photosynthesis gas exchange measurement system (LI-6400, LI-COR, Lincoln, Nebr.) using the following parameters: 28° C. leaf temperature, 21% O₂, 1200 μmol m⁻² s⁻¹ light, 75% relative humidity at 350 pbar CO₂ concentration. The data were collected for four fully expanded young leaves per plant. The results are presented in FIG. 4.

Grapevine leaves were found to be very sensitive to menadione treatment, which resulted in nearly 40% loss in total chlorophyll content within 48 hours at all concentrations tested (as low as 25 mM) as compared to water-treated control leaf discs. In contrast, benzethonium chloride had no appreciable phytotoxicity evident at 25 mM in the chlorophyll degradation assay, whereas 50 mM, 75 mM and 100 mM treatment levels resulted in increasingly significant loss in chlorophyll content.

### Example 2: Menadione and Benzethonium Chloride were Systemic and Efficacious in the Greenhouse Against Pierce's Disease of Grape

Menadione and benzethonium chloride were subsequently evaluated at 5 mM and 25 mM respective concentrations for foliar sprays, and at 15 mM and 50 mM respective concentrations for soil drenches. In greenhouse experiments, sporadic patches of purple pigmentation and necrosis were evident following foliar sprays of menadione, particularly evident wherever the spray droplets accumulated on the leaf blade surface. Visible phytotoxicity was not evident with foliar sprays of benzethonium chloride or with soil drench treatments with either chemical.

Menadione and benzethonium chloride were then evaluated for efficacy against Pierce's Disease by evaluating the progression of Pierce's Disease symptoms in artificially inoculated grapevines. For Xf pathogenicity assays, Vitis vinifera cv. Carignane plants were first inoculated by needle puncture as described (Zhang et al. 2015). Basically, five-day-old Xf cultures were grown in PD medium and resuspended in SCP buffer (trisodium citrate, 1 g/L; disodium succinate, 1 g/L; MgSO4_7H2O, 1 g/L; K2HPO4, 1.5 g/L; and KH4PO4, 1 g/L; pH 7.0) (OD600=0.25). Ten μL droplets of Xf bacterial suspensions were applied with a sterile tuberculin needle on opposite sides of 4-5 internodes of ca. 3 ft high grapevines in 1 gallon pots, starting with the second internode from the base. Plants were not watered for at least 36 hours prior to inoculation, resulting in the droplets of bacterial suspension being drawn quickly into the xylem stream.

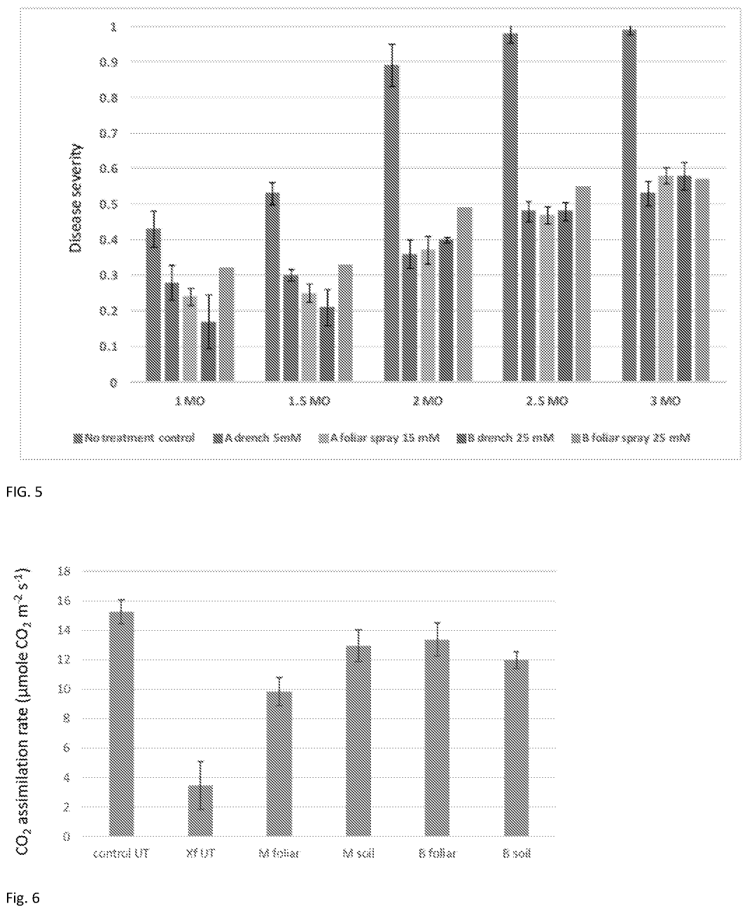

Both menadione and benzethonium chloride significantly delayed progression of PD symptoms in artificially inoculated grapevines (FIG. 5). V. vinifera grapevines treated with 5 mM menadione (A drench) or 25 mM benzethonium chloride (B drench) or 15 mM menadione (A foliar spray) or 25 mM benzethonium chloride (B foliar spray) all showed significantly reduced as well as delayed progression of PD symptoms when assessed over a three month period. Both foliar sprays as well as soil drench treatments were equally effective in attenuation of PD, demonstrating that the chemical treatments became systemic. Following stem inoculations of untreated grapevines with PD strain Temecula 1, ˜40% of the leaves showed PD symptoms at the end on one month period, progressing to nearly 100% of the leaves either defoliated or symptomatic at the end of three months. By contrast, both menadione as well as benzethonium chloride limited the spread of PD symptoms to ˜50% of the leaves at the end of 3 months, with limited defoliation and few bare petioles or nodes.

Chemical treatments were repeated again at the end of the first and second month post-inoculation, for a total of three treatments. Disease severity was quantified by counting the total number of diseased leaves (symptomatic leaves, including bare petioles and bare nodes) and expressed as a % of total number of leaves (symptomatic and asymptomatic (refer Zhang et al. 2015). The effect of chemical A and B treatments (soil drench and foliar spray) on the disease progression over a period of three months is summarized in FIG. 6.

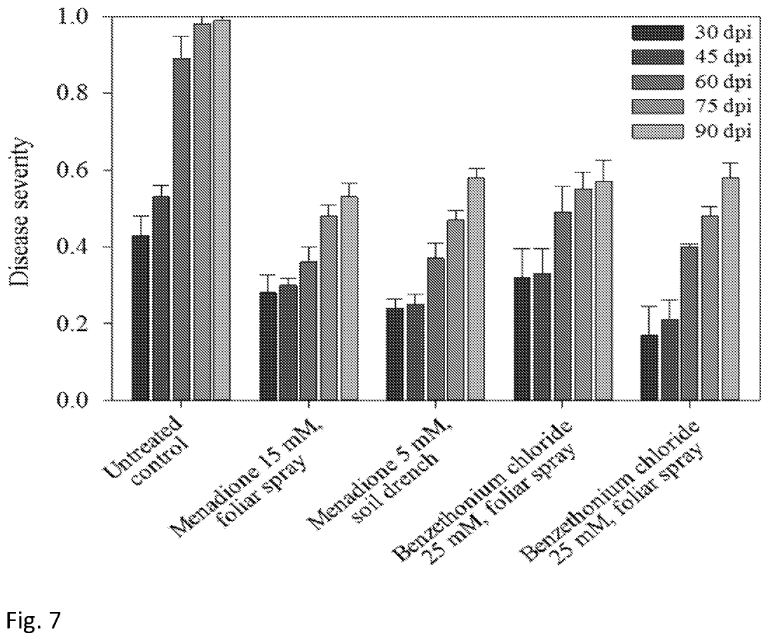

As can be observed in all treated plants, PD disease severity was reduced by approximately 40% by all treatments (FIG. 7). Untreated controls were stunted and died after 3 months; treated plants maintained under the same conditions had longer internodes, and 25% more nodes and continued growing under root-bound conditions. The treatment concentrations were not dose optimized, nor were Xf titers determined. This example demonstrated that these chemical treatments were systemic and efficacious in the greenhouse.

### Example 3: Menadione Soil Drench Treatments are Effective in Controlling the Progression of PD in V. vinifera Qrapevines in Field Conditions

The chemical treatments were applied as soil drenches, either 4× or 8× according to the trial design during the season.

V. vinifera grapevines (200 vines) were artificially inoculated with a well characterized Xf PD strain. Following the menadione treatments, the data on disease progression and other parameters such as chlorophyll florescence are recorded every month.

The field trial was laid out in a randomized block design using 4 V. vinifera vines per replicated block X 6 reps=24 vines per treatment. There are six treatments; half of the treatments are artificially inoculated in the field 3-4 weeks after planting. The other half became randomly naturally infected with Xf as the season progressed. The treatments are manually applied as soil drenches, as follows:

Tmt 1: Soil drench applied 4× (bimonthly) in the year, PD inoculated.

Tmt 2: Soil drench applied 4× (bimonthly) in the year, uninoculated.

Tmt 3 Soil drench applied 8× (monthly) in the year, PD inoculated.

Tmt 4: Soil drench applied 8× (monthly) in the year, uninoculated

Tmt 5: Untreated, PD inoculated.

Tmt 6: Untreated, uninoculated

Expectations are that all untreated, PD inoculated blocks (Tmt5) will die within 4 months of inoculation, and that Tmts 1, 2, 3 and 4 will survive. It is possible that 8× treatments are not needed (Tmts 3 and 4), and that 4× treatments may suffice. It is also possible that 8× treatments will result in some phytotoxicity, detected by chlorophyll measurements.

### Example 4: Menadione Soil Drenches in Commercial Citrus Reduced Las Titer

Las cannot be cultured, and therefore direct assays for bacterial populations infecting a tree cannot be performed. Most investigators utilize PCR based tests to measure bacterial population counts, but it is extremely defective methodology, since bacterial DNA, including DNA from dead bacteria killed by a treatment, is highly persistent in plants, and that since RNA degrades very rapidly after cell death, it is a much more sensitive real time indicator of anti-bacterial therapies (Fittipaldi et al, 2012). Although there are DNA based “live/dead” assays that can be used to detect bacteria in clear samples, environmental samples, such as plant extracts, are so turbid that the required light activation of DNA binding agents such as ethidium or propidium monoazide is impractical. Turbidity is a well-known major limitation of such DNA based assays (Fittipaldi et al., 2012), and such assays are impossible with some bacteria found in environmental samples (Taylor et al., 2014. Microbiology Insights 7: 15-24). Therefore, RNA based assays have been recently adapted for evaluation of treatments designed to cure Las infections of Citrus (Gardner et al. 2016).

Since RNA degrades more rapidly after cell death, it is a much more sensitive real time indicator of anti-bacterial therapy efficacy than any DNA based test (Fittipaldi et al, 2012). To adapt this approach to field trial use, an RNA based live cell assay for Las was improved based on the expression of one of its important pathogenicity factors. In these assays, expression of the Las peroxidase gene is compared to the standard plant housekeeping gene Elongation Factor One alpha (EF1 alpha), using RNA samples removed from midribs of individually labeled leaves. Each infected leaf is tracked and sampled individually at each timepoint. Data from multiple leaves on the same branch were tracked. Nearly 800 leaves were separately labeled and DNA samples taken per each treatment and evaluated by PCR, and well in advance of the treatment application. Of these 800, typically only 100 of the labeled leaves were PCR positive for Las (that is, DNA was present). Only leaves positive for Las DNA were then sampled for RNA on the treatment date and again approximately 3 weeks after treatment. Since titer fluctuation in water control samples are quite large and seasonal, comparisons were made between treatment samples on a given date and water controls taken on the same sampling date.

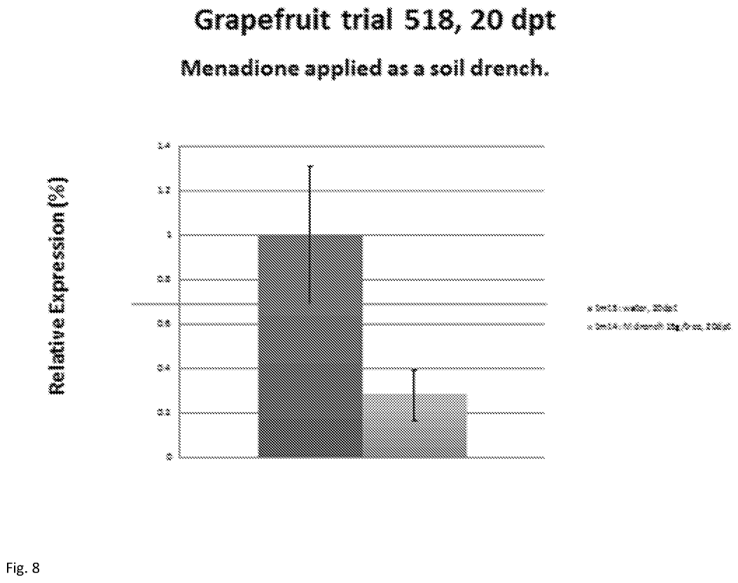

Five year old Hamlins (C. sinensis) and six year old red grapefruits (C. paradisi) in commercial groves that were 100% infected (all trees in the Hamlin and grapefruit blocks were infected) with Las were used for the trial. Six trees in a row were selected for treatments. Soil drench treatments were used. Control plants were untreated The RNA based gene expression assay for the Las SC2_gp095 peroxidase gene was utilized to assess Las titer. The results from menadione soil drench treatments (using 1 g menadione/tree) of Hamlins and 15 g/tree for grapefruits were a measureable suppression of Las metabolic activity as early as 20 days post treatment, as represented in FIG. 8 (only Grapefruit data shown).

### Example 5: Menadione Soil Drenches Proved to Significantly Suppress Las mRNA Activity Systemically in Heavily Infected, Commercial Citrus Groves

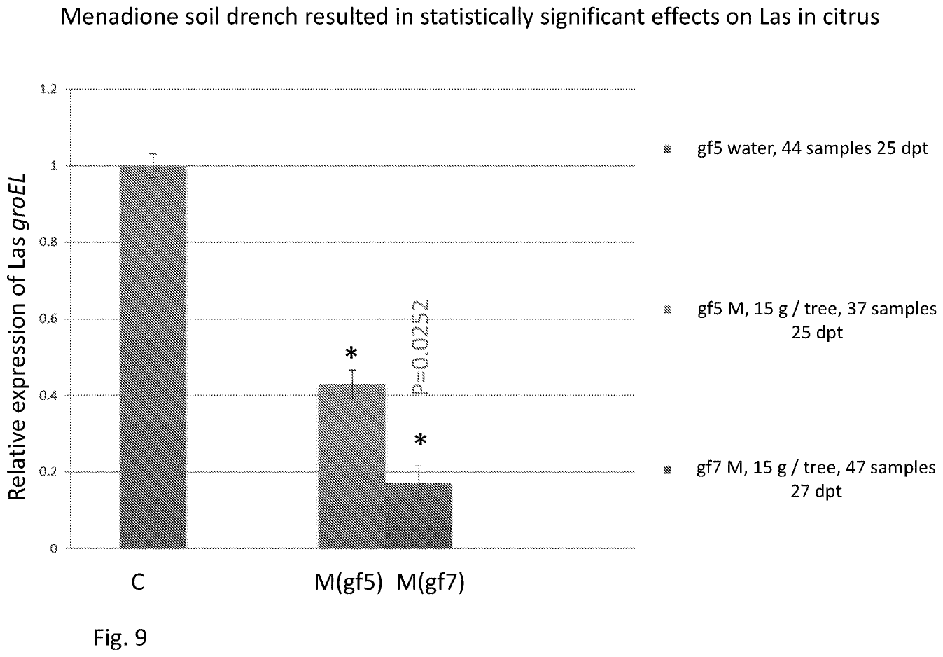

As explained in Example 4 above, the rationale for developing this qRT-PCR assay and rendering it useful for the field is straightforward: although Las detection through the use of DNA based polymerase chain reaction (PCR) methodology is very sensitive, DNA is also very stable and long lived in planta. Therefore DNA based PCR detection methodologies cannot distinguish between dead and live Las bacteria. For example, DNA samples taken following heat treatments of Las infected Citrus still yield high apparent Las titer estimates, despite the fact that the bacteria are later shown to have been dead. Even with the use of “live/dead” reagents such as EMA or PMA, which can help to reduce the amount of dead bacterial DNA in clear liquid cultures, these methodologies utterly fail when the samples are as opaque as Citrus leaf tissue samples containing Las. The problem can be overcome by measuring bacterial messenger RNAs (mRNAs), which are only produced by living bacteria, and bacterial mRNAs have an average half-life of only a few minutes. Specifically, selected target Las mRNAs, such as Las SC2_gp095 peroxidase and Las groEL, work well with qRT-PCR for rapid detection of treatment effects. In FIG. 9 is shown the effects of a single menadione soil drench treatment on Las cells infecting field grown grapefruit in two separate experiments on 4 trees each at 25 and at 27 days post treatment in a completely randomized (each tree a block) field trial. All samples were first confirmed to be positive for Las by real time PCR (rtPCR, a DNA test). In these experiments and by contrast to the results reported in Example 4 and in FIG. 8, statistically significant results can be achieved if the experiments are performed with sufficient sampling effort. The entire experiment, from start to finish, took two months to perform. These menadione treatments showed statistically significant effects by both Student's T and Tuckey's tests at 0.05 confidence levels (FIG. 9).

Although the present invention has been described in considerable detail with reference to certain preferred versions thereof, other versions are possible. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference. Further, the teachings of the references cited herein are incorporated by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of treating a plant disease in a Vitis vinifera plant in need thereof comprising administering to the plant a composition which comprises a botanically compatible vehicle and an effective amount of menadione.

2. The method of claim 1, wherein the plant disease is Pierce's Disease.

3. The method of claim 2, wherein the menadione is at a concentration ranging from 15 μM to 100 mM.

4. The method of claim 3, wherein the menadione is at a concentration of approximately 100 μM, 500 μM, 1 mM, 10 mM, 25 mM, 30 mM, 40 mM or 50 mM.

5. The method of any of claims 2-4, wherein the administering to the plant is by soil injection, soil drenching, or foliar spraying.

6. The method of any of claims 2-4, wherein the administering to the plant is by trunk injection.

7. The method of any of claims 1-6, wherein the plant is infected with Xylella fastidiosa (Xf) or has symptoms of Pierce's disease.

8. A method of improving resistance of a healthy Vitis vinifera plant to Xf, wherein the Vitis vinifera plant is in population of Vitis vinifera plants, the method comprising
administering menadione to the healthy Vitis vinifera plant upon observing that one or more other plants in the population of Vitis vinifera plants are exhibiting symptoms of Pierce's disease or are infected with Xf.

9. The method of claim 8, wherein the menadione is administered in a composition comprising a botanically acceptable vehicle and administering comprises soil drenching, foliar spraying, soil injection, or plant injection.

10. The method of claim 9, wherein the botanically acceptable vehicle comprises water.

11. A method of treating a plant disease in a Citrus plant in need thereof comprising administering to the Citrus plant a composition which comprises a botanically compatible vehicle and menadione.

12. The method of claim 11, wherein the plant disease is Huanglongbing (HLB).

13. The method of claim 12, wherein the menadione is at a concentration ranging from 15 mM to 1 M.

14. The method of claim 13, wherein the menadione is at a concentration of approximately 100 mM.

15. The method of any of claims 11-14, wherein the administering to the plant is by soil injection or soil drenching.

17. The method of any of claims 11-16, wherein the plant is infected with HLB disease or has symptoms of HLB disease.

18. The method of claim 17, wherein the plant is infected with a Candidatus Liberibacter species.

19. The method of claim 18, wherein the Candidatus Liberibacter species is selected from the group consisting of Candidatus Liberibacter asiaticus, Candidatus Liberibacter americanus, Candidatus Liberibacter africanus, and any combination thereof.

20. The method of claim 1 or 8, wherein administering (a) improves resistance to disease, (b) improves the ability to defend against disease, or (c) reduces disease symptoms.

21. A method of improving resistance of a healthy Citrus plant to HLB, wherein the Citrus plant is in population of Citrus plants, the method comprising administering menadione to the healthy Citrus plant upon observing that one or more other plants in the population of Citrus plants are exhibiting symptoms HLB or are infected with a Candidatus Liberibacter species.

22. The method of claim 21, wherein the menadione is administered in a composition comprising a botanically acceptable vehicle and administering comprises soil drenching, foliar spraying, soil injection, or plant injection.

23. The method of claim 22, wherein the botanically acceptable vehicle comprises water.
